(19) United States
(12) Patent Application Publication
(10) Pub. No.: US 2007/0124280 A1
(43) Pub. Date: May 31, 2007

(54) Search Engine which awards Point per Click

(76) Inventor: Tony Tateossian, Montrose, CA (US)

Correspondence Address: JEFFREY FURR, 253 N. MAIN STREET, JOHNSTOWN, OH, 43031, US

(21) Appl. No.: 11/164,502

(22) Filed: Nov. 27, 2005

(51) Int. Cl. G06F 17/30

(52) U.S. Cl. 707/3

(57) ABSTRACT

The current invention is a search engine that will allow users to save money in their net advertising budget and promote a site for free. The system is easy to use: a user simply searches or surfs through the websites in the system's search engine database and, in doing so, earn Points that automatically send Targeted Traffic to a desired website. Unlike other web traffic driving systems, with the current invention a user receives real targeted traffic for the Points they earn.

### BACKGROUND OF INVENTION

1. Field of Invention

The present invention relates to search engines and more particularly a search engine that awards points per click.

2. Description of Prior Art

Since the dawn of commerce, business owners haven't succeeded by opening shop, then sitting back and waiting for customers. They've had to compete—initially by standing outside their stores and yelling in the marketplace—and from that point, active advertising was born. One of the most fundamental shifts in the way companies conducted business during the late 1990s and early 2000s arose from the increased practice of online product ordering. This type of business is referred to as e-business, e-commerce, or I-commerce (for Internet commerce). This shift represented a change in business strategy as much as in technology, as IBM chairman Lou Gerstner stated in InformationWeek: “E-business moves the agenda of the IT industry back into the CEO's office.” IBM was among the first companies seeking to profit from the opportunity to provide corporate customers with e-commerce hardware, software, and services. Some ten thousand of IBM Global Services' 130,000 employees were dedicated to developing e-business systems and services for clients, and in 1997 e-business was responsible for 25 percent of IBM's US $78 billion in revenue. Clients using IBM's services included Woolworth, Merrill Lynch, and Proctor & Gamble.

In December of 2001, some 137 million host computers tapped into the Internet, a rise of 40 percent from the 97 million similarly connected just two years earlier, according to Network World magazine. (The number of host computers can be detected by assessing how many OP addresses have been assigned a domain name.) Companies offering access to the Internet and related services, such as security and navigation, are well positioned to capitalize on this rapid growth.

By 2002, with many “dot-coms” seemingly in full flight or bankrupt, the Internet was being viewed in more realistic terms by analysts. In the fourth quarter of 2001, domain name registrations dropped for the first time, at least partially caused by speculators who chose domain names in hope of selling and then opted not to renew their registrations when they failed to find buyers. While online activity per person dropped 10 percent from 2000 to 2002, it still commands a reasonably high average of 83 minutes each day. According to the Daily Telegraph in Sydney, Australia, fewer people say they are finding items of informational value online: that rate fell from 50 percent in 2000 to 39 percent in 2002. In addition, about 20 percent of new Web sites fold or go inactive just nine months after startup, the paper reported in 2002. Nonetheless, the Internet has become an integral part of the world's corporate culture, and its importance cannot be overstressed as a vital commerce tool. At the start of 2002, according to Network World, 62 percent of all adults had connected at least three times in the past 90 days.

The late 1990s and the first years of the twenty-first century were thought to be particularly important in the Internet services industry. Tom Steinert-Threlkeld reported in Inter@ctive Week that Internet service providers would have to be either very large or very small in order to survive in the industry. Large ISPs would be able to offer lower pricing because of sheer volume, and small companies could offer fast, personal service. Increased consolidation in the industry was promising to swallow up a good number of the sized companies. Consolidations were expected to occur most frequently between ISPs, local telephone carriers, and long-distance carriers. Indeed, AT&T Corporation's 1998 acquisition of cable television giant TeleCommunications Inc. (TCI) may serve as a precedent for such combination. While the merger affected many industries beyond Internet services, AT&T's WorldNet was already a major U.S. ISP, and TCI was in the throes of launching a cable-based Internet service. Together, the companies had the potential to reach more than a third of all U.S. households with a package of integrated information services including local and long-distance phone service, Internet access, and pay television. Bob Matcalfe, Vice President of Technology for International Data Group, felt that only specialization could save companies from absorption. He believed that such companies should specialize in smaller subgroups of the larger Internet services industry, such as providing basic access, reselling service, providing backbone capacity, providing roaming capacity, or aggregating content.

According to William Ebeling and Todd Wood in InformationWeek, the Internet and the various services surrounding it were also changing the way businesses and chief executives regarded information services (IS) departments. No longer were executives able to regard technology as a support tool and leave decision-making to technology experts. In the late 1990s through the early 2000s, business managers and executives needed to regard the Internet as another means for delivery of company products, customer service, and marketing. “Internet strategy” was fast becoming a part of companies' business plans. Karen Askey, senior vice-president of consumer markets at Preview Travel, an online travel agency, believed the Internet created an entirely new business model.

Additionally, partnerships and alliances were becoming far more important than in previous years. One example of collaboration on the Internet was Citibank's decision to build an international e-commerce infrastructure based on Netscape's software in order to reach a corporate goal of 1 million customers by 2010. Citibank believed that automating processes on the Internet would help them reach this goal more quickly than simply opening more bank branches, and they planned to use Netscape's CommerceXpert application to do so. Citibank's network would not be limited to PCs but would also be accessible via automatic teller machines (ATMs), pagers, cellular phones, and handheld computers.

Many companies specialize in Web hosting, Web site design, and programming services. Web hosting service provides server or network space to companies or individuals wishing to publish a Web site on the Internet. This type of service is often included among the service offerings of larger Internet service providers, sometimes as part of a package customers receive when they sign up for Internet access. For example, an access provider might make available a certain quantity of server disk space (such as 5 megabytes) to each customer that purchases a service contract. Customers can then design and post their own Web site on the Internet using that service provider's network resources. In 1998 about 65,000 new Web pages were created every hour.

Web site designers are often called upon to perform the functions of several professionals, such as graphic artists, software programmers, and network administrators. Web sites need to be aesthetically pleasing so that they appeal to Internet “surfers” and build repeat visitors. If a site is at all complex and requires tasks such as database access and manipulation or electronic commerce, more extensive programming than the Internet's standard publishing language (hypertext markup language-HTML) is needed. Maintaining the Web site and ensuring that its host network runs smoothly can be additional responsibilities. For these reasons, many companies offering comprehensive Web services hire specialized personnel for each step. Most if not all web site owners and operators seek to maximize the number of users who access their web site. In the case of web sites offering products or services for sale, it is obviously desirable for the web site to be located as close as possible to the top of the list of search engine results for a search relevant to the site's content for maximum exposure to the most users.

Web sites exposed to more users have more chances to convert a user. Conversion is when the user initiates an action of consumer significance on a web site, such as providing information to a web site host, making a purchase, requesting information, contacting someone at the web site sponsor, or requesting such contact information. For example, web sites that receive revenue from advertisers each time a user accesses an advertising banner on the site (usually by clicking it with a mouse) seek to maximize site exposure to users and also maximize the number of users converted by clicking on an advertising banner. Increasing the relevance ranking a web page is assigned by search engines is a high priority for a web site owner.

Multiple factors play a role in the determination of a web page's relevance, including the location and frequency of keywords on a web page. If the keyword is located in prime position on the page and/or occurs frequently, the search engine may rank that page “relevant” or “highly relevant” for that keyword search. A web page's title plays a prominent role in ranking its relevance. Text found close to the top of a page is also significant to the ranking of a page by search engines. Other factors in evaluating relevance include keyword density (the ratio of the number of times the keyword appears to the total number of words appearing on the web page) and total number of times the keyword appears.

Web pages containing keywords that are meta-tagged (have commands inserted into a web page that provide information about the web page) have an added advantage with some search engines. Tags are used by most format specifications that store documents as text files, including Standard Generalized Markup Language (SGML) and Hypertext Markup Language (HTML). For search engine indexing, title, description, and keyword tags are the most essential of all types of meta-tags. The title tag contains the title of the web page, the description tag returns a suggested additional description of the page to the search engine, and the keyword tag provides a list of one or more words the site owner wants the search engine to associate with the page.

Prior Art

U.S. Pat. No. 6,907,424 issued on Jun. 14, 2005, and U.S. Pat. No. 6,324,534 issued on Nov. 27, 2001, by Neal, et al., are for a Sequential subset catalog search engine. It discloses a method and apparatus to perform cascading search methodologies on one or more data sets from one or more databases.

U.S. Pat. No. 6,763,362 by McKeeth and issued on Jul. 13, 2004, is for a Method and system for updating a search engine. It discloses a method and a system for maintaining the freshness of a search engine server's database. A popularity parameter is defined, and a popularity value is assigned to each link in the search engine's database. The most popular links are selected for updating the contents stored, or associated with, the site to which the links refer.

U.S. Pat. No. 6,169,992 by Beall, et al. and issued on Jan. 2, 2001, is for a Search engine for remote access to database management systems. It discloses a system for remotely accessing database management systems and performing guided iterative queries of knowledge bases over a communication circuit such as the Internet.

U.S. Pat. 6,125,361 by Chakrabarti, et al. and issued on Sep. 26, 2000, is for a Feature diffusion across hyperlinks. It discloses a system and method for ranking wide area computer network (e.g., Web) pages by popularity in response to a query. Further, using a query and the response thereto from a search engine, the system and method finds additional key words that might be good extended search terms, essentially generating a local thesaurus on the fly at query time.

United States Patent Application 20050177562 by Raciborski and published on Aug. 11, 2005, is for a Universal search engine. It discloses a search system for searching intranet datasets and Internet datasets. Included in the search system are a first interface portion, a preference and a search translation unit.

United States Patent Application 20040083127 by Lunsford, et al. and published on Apr. 29, 2004, is for a Web site and method for search engine optimization by prompting, recording and displaying feedback of a web site user.

United States Patent Application 20030217059 by Allen, et al. and published on Nov. 20, 2003, is for a System and method for internet search engine. The search engine is capable of producing relevant search results in a ranked order, which is at least partially determined by the web site providers themselves. The search engine is preferably fee-based and policed to provide relevant search results to the end user.

There is still room for improvement in the art.

### SUMMARY OF INVENTION

The current invention is a search engine that will allow users to save money in their net advertising budget and promote a site for free. The system is easy to use: a user simply searches or surfs through the websites in the system's search engine database and, in doing so, earns Points that automatically send Targeted Traffic to a desired website. Unlike other web traffic driving systems, with the current invention a user receives real targeted traffic for the Points they earn.

The current invention utilizes the Internet. The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that affects the requesting of Web pages and the displaying of Web pages.

The system is more efficient, effective, accurate and functional than the current art.

### DEFINITIONS

Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Server host: a computer on the Internet that hands out Web pages through a Web server program.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Visit: a series of requests to a fixed Web server by a single person (through a browser), occurring contiguously in time.

Web master: the (typically technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF DRAWINGS

Without restricting the full scope of this invention, the preferred form of this invention is illustrated in the following drawings:

FIG. 1 shows an overview of how a User accesses the system through the Internet;

FIG. 2 shows an overall view of the system;

FIG. 3 displays sample results of a search;

FIG. 4 displays a member's earned points; and

FIG. 5 displays how an affiliate program would earn monetary compensation following description is demonstrative in nature and is not intended to limit the scope of the invention or its application of uses.

There are a number of significant design features and improvements incorporated within the invention.

The current invention is a search engine, the System 1 that will allow users to save money in their net advertising budget and promote a site for free. The system is easy to use: a user simply searches or surfs through the websites in the system's search engine database and, in doing so, earns Points that automatically send Targeted Traffic to a desired website.

The computer application that includes the user interface for this invention will henceforth be referred to as “the System 1.” The system is network-based and works on an Internet, Intranet, and/or Wireless network basis as well as a stand alone and fax-based system.

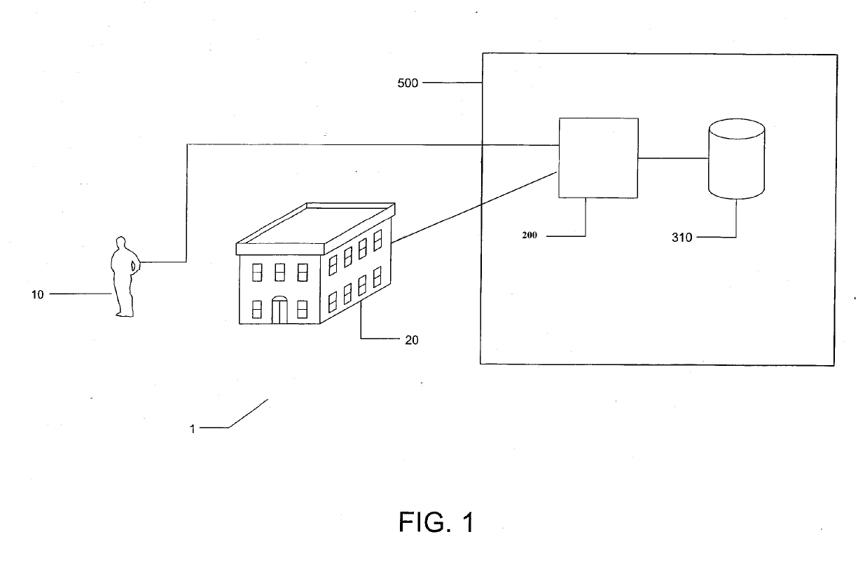

FIG. 1 illustrates a functional diagram of a computer network for World Wide Web 500 access to the System 1 from a plurality of Users 10 who accesses the system Web Site 100 or the Users 10 can connect directly to the System 1 using their computer 35. Accessing the System Web Site 100 can be accomplished directly through a communication means such as a direct connection, an intranet, a local Internet Service Provider, often referred to as ISPs, or through an on-line service provider like CompuServe, Prodigy, American Online, etc. or Wireless devices using services like AT&T or Verizon.

The Users 10 contact the System Web Site 100 using an informational processing system (Client) capable of running an HTML compliant Web browser such as Microsoft's Internet Explorer, Netscape Navigator, Lynx and Mosaic. A typical system that is used is a personal computer with an operating system such as Windows 95, 98 or ME, NT, 2000 or Linux, running a Web browser. The exact hardware configuration of computer used by the Users 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

In one preferred embodiment of the invention, the Users 10 connect to the System Web Site 100. In the preferred embodiment the system has numerous web pages. The information in the web pages is in HTML format via the HyperText Transport Protocol (http) and on Server System 310. The User System 310 includes software to allow viewing of web pages, commonly referred to as a Web Browser, such as Communicator available from Netscape Communications Corp. or Internet Explorer available from Microsoft Corp. The user system is capable of accessing web pages located on Server System 310.

The days of “build it and they will come” are long gone for the internet. In today's over-stimulated communications environment, small to mid-sized businesses are unlikely to garner enough attention from prospects to create sufficient demand. Businesses must have the knowledge of how they can profit from this new technology. Local business owners, particularly, continue to struggle with how to reach their target market of local consumers online. In addition, consumers in search of local businesses are still only left with the hard copy of the telephone Yellow Pages as their sole reference source. The internet, in itself, remains a global means of ecommerce while a significant percentage of businesses and consumers are focused on local. This continued search for a solution has required many business owners to become technically proficient in coding their websites with keywords for search engine optimization or invest their profits to outsource the function-neither option allowing them to focus on their core business competencies.

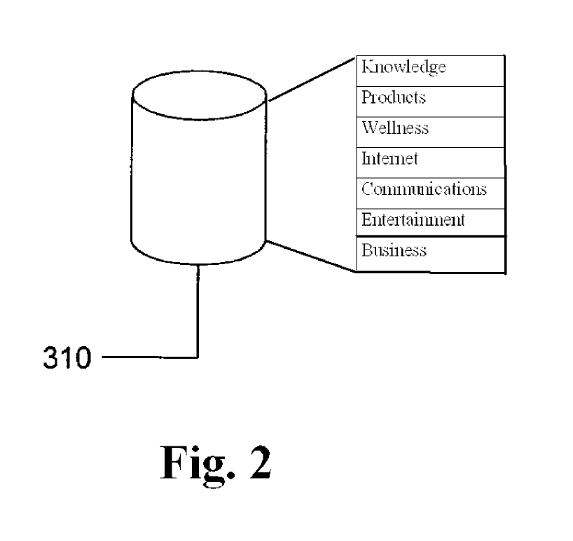

As shown in FIG. 2, the System 1 is an internet search engine process that provides free web traffic driven by targeted web clicks based on seven (7) categories within the database 310: Knowledge, Products, Wellness, Internet, Communications, Entertainment and Business. It is designed as a cost-effective way to drive targeted traffic to a user's website. The System 1 is extraordinarily easy to use: a user simply searches or surfs through the websites in the search engine database 310 earns points that automatically send targeted traffic to the user's desired website. When a member 20 maintains a high Points balance, the member website will be listed prominently in the System's search engine results, which generates more targeted traffic for the back-end user 10.

To add a site to the system 1, a member 20 simply submit a description of the site, along with its URL.

Upon joining the System 1, the member website 200 is listed immediately and receives Free Internet Traffic. Unlike prior art where most usual search engines typically take up to three months, the System 1 will list each member website 200 in their search engine immediately after the site 200 is submitted. Once the site 200 is listed with the System 1, the site is added to the database 310 so that the member 20 will benefit immediately from search engine traffic, free web advertising and free web hits.

In the preferred embodiment, the System 1 lets website owners/members 20 utilize three types of search engine advertising:

Surf Page: The system's 1 Surf Page will allow a user 10 to see the entire web page rather than listings found in the system's Search Page. The user 10 searching would automatically enter the members 20 site rather than selecting one from a list. In order to rank in a higher position within The System's 1 Surf Page, a member must maintain a high Point balance. As long as a member's account maintains Points, the System 1 sends highly Targeted Traffic to the member's website 200.

Highlighted listings on the right hand column of the search engine: Once a member's website 200 is submitted it will be displayed or highlighted on the right hand column of the search engine. This will be Free of charge in the preferred embodiment.

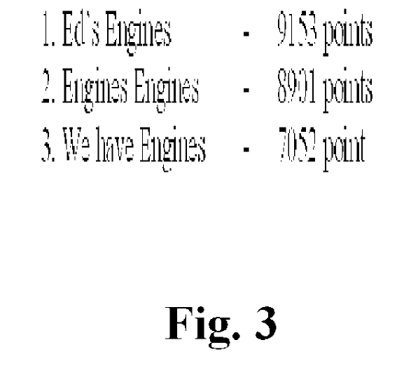

Position 1, 2, or 3 of the search: In prior art, the top three positions of a search usually required a huge advertising budget with typical search engines. The System 1 will award these positions based on the number of points that a member has. FIG. 3 displays a sample of the 1st, 2nd and 3rd position of the search with their respective points.

The System 1 is designed to provide numerous ways for members 20 to earn points and expand their usage:

In the preferred embodiment, each time a member uses the search engine to make a search they will earn Points and thus, earn traffic for their website 200. A sample awarding of points would be that a member 20 would earn 1 Point each time they perform a search and 1 Point each time they click on a link.

Points will also be awarded when a member 20 makes the System's website 100 their home page; for example a member 20 can earn 2000 Points for making the System's website 100 their home page and then earn one point each time they log onto the site thereafter.

Points will also be awarded for Referrals made by the member 20 to the system 1. In the preferred embodiment, chains of referral will be allowed up to 5 levels so that a member 20 will receive points for a referral from their referral. Each level is called a tier, so there would be first, second, third, forth and fifth level tiers. Referrals can be made by a URL pointing to the system 1 that is placed on the member's website 200. In the preferred embodiment, a member would be assigned an affiliate ID or personal URL, which they can use to promote the System 1. A member 20 may also use the system's 1 banners, links, and pop unders to promote their affiliate URL.

The system 1 would have the capability in the preferred embodiment for members 20 to earn monetary payments such as cash in addition to or instead of points in the tiered affiliate program cash. The system's 5 tier affiliate program will work as a Multi-level marketing program.

Example: Http://www.the System's website 100/affiliateXXXXXX (XXXXXX will be replaced with the member's affiliate ID)<br> Once a member's visitors come to the system's site 100 via the link above, the member's affiliate ID will be saved on the visitor's computer as a cookie for up to six (6) months. So if the visitor comes back and signs up later or purchases many months from now the member will still receive credit for it.

Based on our extensive market research a good percentage of our visitors will sign up to our Free Traffic Rewards Program. Once your visitors' sign up, your affiliate ID will be hard coded into our database forever and you'll get paid when they purchase advertising from The System 1.

The system 1 will also award points to members 20 who utilize the System's 1 Banner.

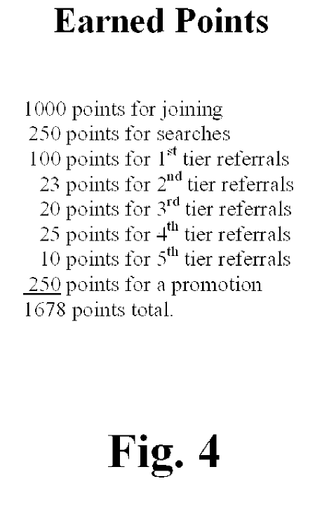

The system 1 will also award points based on promotions such as sign bonuses and referral bonuses. FIG. 4 displays a sample of a member's earned points. The member 20 earned 1000 points for joining, 250 points for searches, and 100 points for 1st tier referrals, 23 points for 2nd tier referrals, 20 points for 3rd tier referrals, 25 points for 4th tier referrals, 10 points for 5th tier referrals and 250 points for a promotion for a total of 1678 points.

The System 1 in the preferred embodiment will have a Powerful Anti-Villain System in place that will effectively ban the Villains IP address or anyone who tries to gain Points by inappropriate and/or disallowed means. Anyone caught cheating by the Anti-Villain System will be permanently blocked from using the System 1 and his/her name, IP addresses, and email addresses will be blacklisted from the System 1 permanently.

The System 1 will monitor for people who try to get more Points by clicking on the “GO” buttons too quickly. In order to stop them, the system 1 freezes their system and send them a warning message, telling them not to click “GO” too quickly without reading some of the links or web sites.

Some people may try to load their personal URL page too many times in one day on the same IP address or by using auto-clicking software. In order to discourage this type of activity, the system will allow for a maximum number of Points per day for clicking onto their home page URL by the same IP address or membership account.

Some people may try to use auto-clicking software to earn Points in the surf section. In order to put a stop to this type of activity, the system 1 asks users to input a security code every 10-25 minutes in order to continue earning Points.

Members 20 who report Villains or ways to cheat the system 1 will be awarded points.

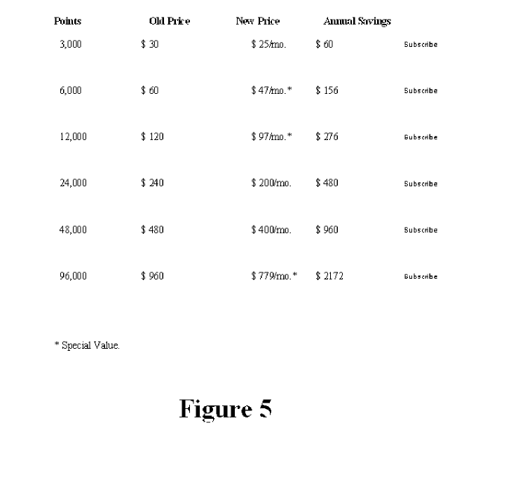

In the preferred embodiment, members 20 can also earn points by downloading a system Download Explorer Toolbar. They can also earn points by inserting a Search Box at their website 200. They can earn point by inserting an Ad box at their site as shown in FIG. 5.

The system 1 will have a Member Banner Exchange, where Members 20 interchange banners with each other for additional traffic,

The system 1 is set to run on a computing device. A computing device on which the present invention can run would be comprised of a CPU, Hard Disk Drive, Keyboard, Monitor, CPU Main Memory, and a portion of main memory where the system resides and executes. A printer can also be included. Any general purpose computer with an appropriate amount of storage space is suitable for this purpose. Computer Devices like this are well known in the art and are not pertinent to the invention. The system can also be written in a number of different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A method of searching website, the method comprising:
having a system award points to members; and
listing members in search in an order that is based on the amount of points that they have earned.

2. The method as described in claim 1, further comprising having said search be a keyword search.

3. The method as described in claim 1, further comprising having said search based on a plurality of categories.

4. The method as described in claim 3, further comprising having said categories being one or more selected from a group of knowledge, products, wellness, internet, communications, entertainment and business.

5. The method as described in claim 1, further comprising having said member join the system by submitting a description of the site to be added and said site's URL.

6. The method as described in claim 5, further comprising having said member be searchable on said system immediately on joining.

7. The method as described in claim 1, further comprising having said system using a searchable database to save said members.

8. The method as described in claim 7, further comprising having new members who join the system being immediately added to said database.

9. The method as described in claim 1, further comprising having said system having a surf page.

10. The method as described in claim 9, further comprising having said surf page allowing viewing of the entire web page.

11. The method as described in claim 1, further comprising having highlighted listings displayed by said system.

12. The method as described in claim 1, further comprising having said member earn points by using the system for a search.

13. The method as described in claim 1, further comprising having said member earns points by making said system their home page.

14. The method as described in claim 1, further comprising having said member earns points by referring said system to others.

15. The method as described in claim 14, further comprising having said member earns points by any referrals from any of their referrals.

16. The method as described in claim 1, further comprising having said member earns monetary compensation by referring said system to others.

17. The method as described in claim 16, further comprising having said member earns monetary compensation by any referrals from any of their referrals.

18. The method as described in claim 1 further comprising having said means to prevent inappropriate awarding of points.

19. The method as described in claim 1, further comprising having said member earns points by notifying of inappropriate awarding of points by another member.

20. The method as described in claim 1, further comprising having said system have a banner page and having said member earn points by utilizing the system's banner page.
